(19) United States
(12) Patent Application Publication
(10) Pub. No.: US 2004/0010413 A1
(43) Pub. Date: Jan. 15, 2004

(54) Action voice recorder

(76) Inventor: Taka Y. Takei, Diamond Bar, CA (US)

Correspondence Address: Raymond Y. Chan, Suite 128, 108 N. Ynez Ave., Monterey Park, CA, 91754, US

(21) Appl. No.: 10/192,119

(22) Filed: Jul. 11, 2002

(51) Int. Cl. G10L 21/00

(52) U.S. Cl. 704/272

(57) ABSTRACT

An action voice recorder includes a casing having a receiving cavity, a power source, a cartoon figurine comprising a movable operating part mounted on the casing, a voice generator, which is disposed in the receiving cavity, comprising a voice activator electrically connected with the power source for generating a voice message and a sound converter electrically connected with the voice activator for converting the voice message in an audible form, and a voice actuator electrically connected to the voice generator and arranged in such a manner that when the voice generator is activated, the voice actuator actuates the movable operating part of the cartoon figurine to move in synchronization with respect to the voice message.

### BACKGROUND OF THE PRESENT INVENTION

1. Field of Invention

The present invention relates to a voice recorder, and more particularly to an action voice recorder, wherein a movable operating part of a cartoon figurine is operatively linked to a voice generator in such a manner that when the voice generator generates a voice message, the cartoon figurine is activated to provide a figure movement thereof.

2. Description of Related Arts

Everyday, we often suddenly think of tasks, people, events that we want or need to remember. For example, in the office, administrators may need to write down thousands of memos such as phone messages and time schedules for internal usage. When we need to take a message such as a phone number of a friend or a short notice, we first may look for a pen and a piece of paper. Sometime it is embarrassing that we have to get a pen from our pocket and find paper in the briefcase. Therefore, most people, especially business people, would like to use a voice recorder for recording the voice message instead of writing down the message on the paper.

In other words, the sender can simply record his or her voice in the voice recorder such that by activating the voice recorder, the recipient can replay the voice message to get the message from the sender. For example, parents are able to leave a voice message for their young kids such that when the young kids come back home from school or wake up in the morning, they are able to retrieve the voice message. However, the young kids may not pay attention on the voice message even though the voice message sounds like the voice of their parents.

### SUMMARY OF THE PRESENT INVENTION

A main object of the present invention is to provide an action voice recorder, wherein a movable operating part of a cartoon figurine is operatively linked to a voice generator so that when the voice generator generates a voice message, the cartoon figurine is activated to provide a figure movement thereof.

Another object of the present invention is to provide an action voice recorder, wherein the figure movement of the cartoon figurine is capable of attracting the attention of a young child to listen to the voice message.

Another object of the present invention is to provide an action voice recorder, wherein the voice message can be instantly recorded and replayed by the voice generator instead of recording a written message by using a pen and a piece of paper.

Another object of the present invention is to provide an action voice recorder, wherein the operation of the action voice recorder is simple and easy, specifically designed for the young child to operate the present invention.

Another object of the present invention is to provide an action voice recorder, wherein the figure movement of the cartoon figurine is co-related with the voice message so as to provide an animating effect of the cartoon figurine.

Another object of the present invention is to provide an action voice recorder, capable of incorporating with a clock or a radio such that the figure movement of the cartoon figurine can be activated with respect to the time or the music from the voice generator.

Another object of the present invention is to provide an action voice recorder, wherein no expensive or complicated mechanical structure is required to employ in the present invention in order to achieve the above mentioned objects. Therefore, the present invention successfully provides an economical and efficient solution for providing a voice recording function and the figure movement of the cartoon figurine in synchronization with respect to the voice message.

Accordingly, in order to accomplish the above objects, the present invention provides an action voice recorder, comprising:

a casing having a receiving cavity;

a power source;

a cartoon figurine comprising a movable operating part mounted on the casing;

a voice generator, which is disposed in the receiving cavity, comprising a voice activator electrically connected with the power source for generating a voice message and a sound converter electrically connected with the voice activator for converting the voice message in an audible form; and

a voice actuator electrically connected to the voice generator and arranged in such a manner that when the voice generator is activated, the voice actuator actuates the movable operating part of the cartoon figurine to move in synchronization with respect to the voice message.

### BRIEF DESCRIPTION OF THE DRAWINGS

FIG. 1 is a perspective view of an action voice recorder according to a first preferred embodiment of the present invention.

FIG. 2 is an exploded perspective view of the action voice recorder according to the above first preferred embodiment of the present invention.

FIG. 3 is a circuit diagram of the action voice recorder according to the above first preferred embodiment of the present invention.

FIG. 4A is a sectional view of the action voice recorder according to the above first preferred embodiment of the present invention, illustrating an operation of action voice recorder.

FIG. 4B illustrates an operation of a movable operating part of the action voice recorder according to the above first preferred embodiment of the present invention.

FIG. 5 is a perspective view of an action voice recorder according to a second preferred embodiment of the present invention.

FIG. 6 is a sectional view of the action voice recorder according to the above second preferred embodiment of the present invention.

FIG. 7 is a circuit diagram of the action voice recorder according to the above second preferred embodiment of the present invention.

FIG. 8 is a perspective view of an action voice recorder according to a third preferred embodiment of the present invention.

FIG. 9 is a sectional view of the action voice recorder according to the above third preferred embodiment of the present invention.

FIG. 10 is a circuit diagram of the action voice recorder according to the above third preferred embodiment of the present invention.

### DETAILED DESCRIPTION OF THE PREFERRED EMBODIMENT

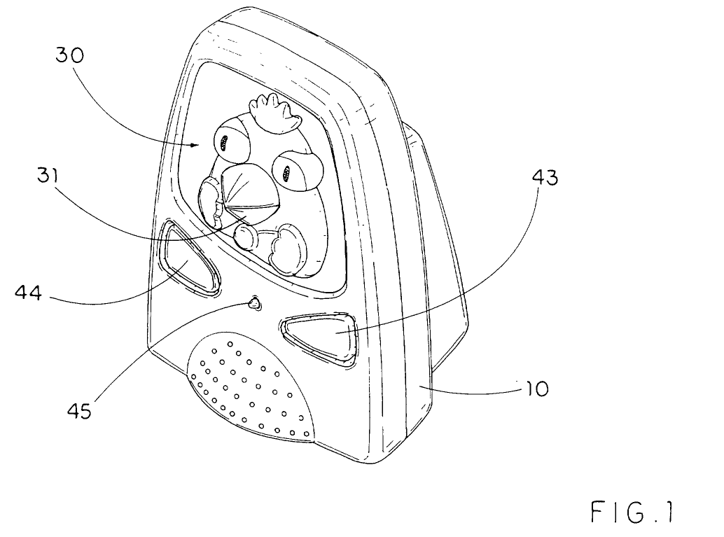

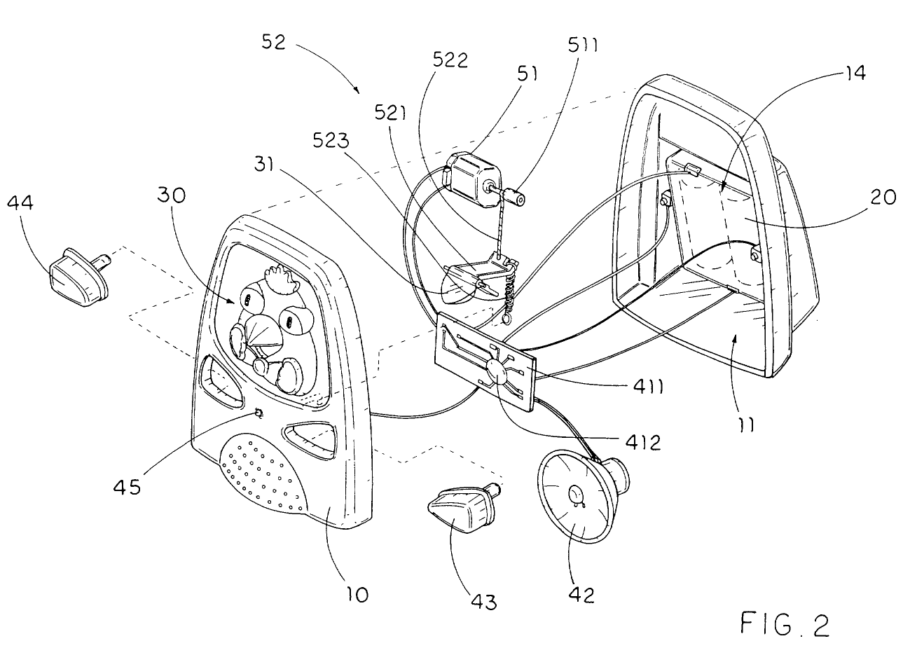

Referring to FIGS. 1 and 2 of the drawings, an action voice recorder according to a first preferred embodiment of the present invention is illustrated, wherein the action voice recorder comprises a casing 10 having a receiving cavity 11, a power source 20, and cartoon figurine 30 comprises a movable operating part 31 mounted on the casing 10.

The action voice recorder further comprises a voice generator 40 and a voice actuator 50.

The voice generator 40, which is disposed in the receiving cavity 11, comprises a voice activator 41 electrically connected with the power source 20 for generating a voice message and a sound converter 42 electrically connected with the voice activator 41 for converting the voice message in an audible form.

The voice actuator 50 is electrically connected to the voice generator 40 and arranged in such a manner that when the voice generator 40 is activated, the voice actuator 50 actuates the movable operating part 31 of the cartoon figurine 30 to move in synchronization with respect to the voice message.

According to the preferred embodiment, the casing 10, being hand held sized, comprises a front panel 12 and a rear panel 13 to form the receiving cavity 11 therebetween to receive the voice generator 40. The casing 10 further comprises a battery chamber 14 provided within the receiving cavity 11. Since the action voice recorder of the present invention is specifically designed for a young child, the casing 10 should be handy that the young child is able to carry the present invention easily.

As shown in FIG. 2, the power source 20 is embodied as a replaceable battery disposed in the battery chamber 14 wherein the replaceable battery of the power source 20 is electrically connected to the voice generator 40 by means of connecting wires 21 so as to supply the electricity to the voice generator 40.

The movable operating part 31 of the cartoon figurine 30 is movably mounted on a front side of the casing 10, which is the front panel 12 thereof, wherein the cartoon figurine 30 is embodied as an attractive cartoon character that is capable of attracting a young child's attention. The movable operating part 31 of the cartoon figurine 30 is embodied as a lip portion thereof pivotally mounted to the front side of the casing 10 such that when the movable operating part 31 is driven to move, the movable operating part 31 of the cartoon figurine 30 works in synchronization with respect to the voice message.

The voice generator 40, according to the first embodiment, is a voice recording device adapted to record a voice from a user to form the voice message and play back the voice message through the voice converter 42.

The voice activator 41 comprises a transistor circuit 411 electrically connected with the power output 20 and a voice recording device 412 electrically mounted on the transistor circuit 411 for recording and storing the voice message from a user in such a manner that by activating the voice activator 41, the voice message stored in the voice recording device 412 is played through the voice converter 42.

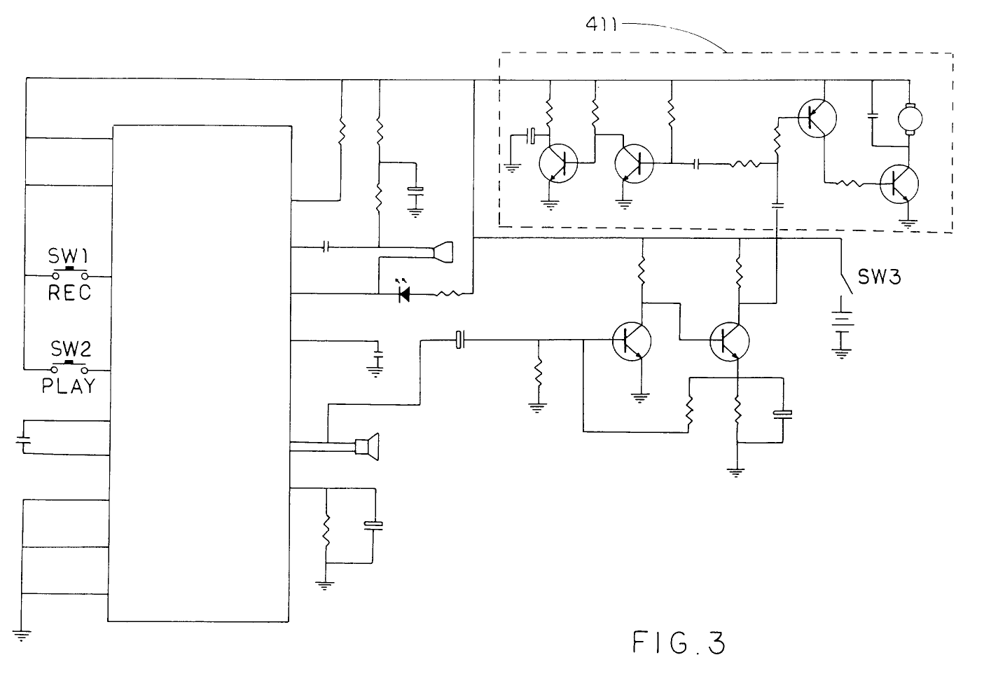

The transistor circuit 411 is a circuit design, as one example is shown in FIG. 3, to incorporate the voice converter 42 with the voice actuator 50 wherein the transistor circuit 411 is arranged to provide a communication between the voice recording device 412 and the voice converter 42 and a communication between the voice converter 42 and the voice actuator 50.

The voice recording device 412, which is embodied as a voice capacitor, is adapted for transforming an audible signal to an electric impulse in such a manner that the voice message is converted to the electric impulse to be stored in the voice recording device 412. Accordingly, the voice recording device 412 has a predetermined voice storage capacity for storing a predetermined time length of the voice message.

The voice converter 42 is preferably a loudspeaker wherein the electric impulse formed voice message stored in the voice recording device 412 is adapted for converting back to the audible sound through the voice converter 42. Accordingly, the loudspeaker of the voice converter 42 is capable of providing a better sound quality so that the voice message sounds like the voice of the user. It is worth mentioning that the voice converter 42 can be a buzzer to convert the voice message from the voice recording device 412 so as to minimize the cost of the action voice recorder of the present invention.

The voice actuator 50 comprises a motor 51 operatively connected to the transistor circuit 411 to drive an output axle 511 to rotate, and means 52 for actuating the movable operating part 31 of the cartoon figurine 30 to move when the output axle 511 is rotated.

As shown in FIG. 2, the motor 51 is electrically connected to the transistor circuit 411 and arranged in such a manner that the transistor circuit 411 sends signal to the motor 51 to drive the output axle 511 to rotate. In other words, an on and off manner of the motor 51 is operated by the transistor circuit 411 so as to convert an electrical power to a mechanical power through the output axle 511.

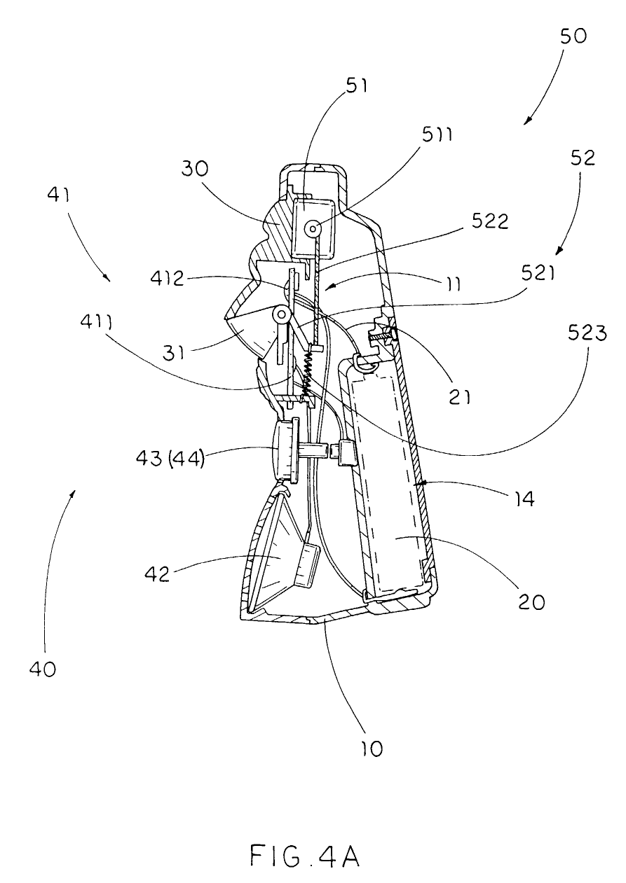

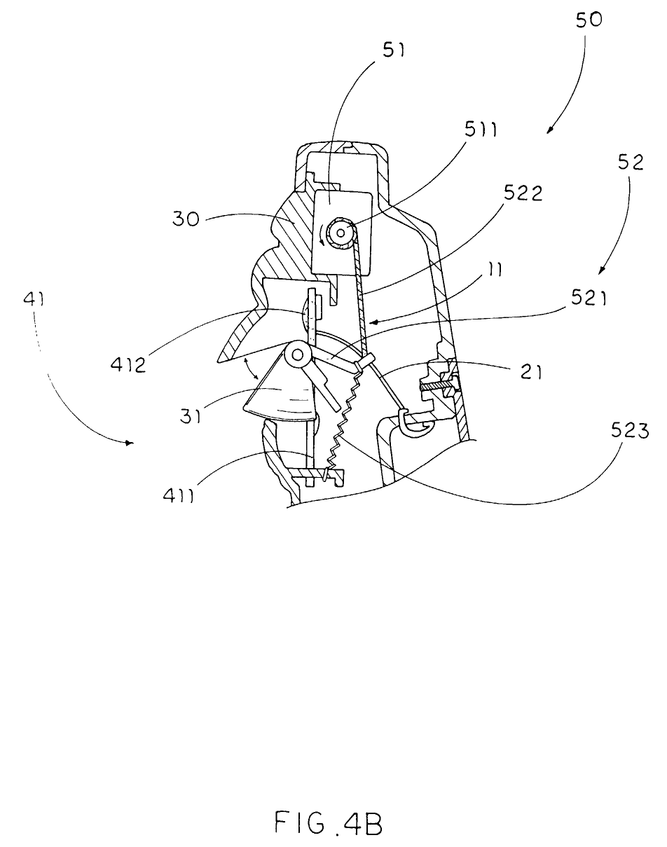

As shown in FIG. 4A, the actuating means 52 comprises a driving arm 521 extended from the movable operating part 31 of the cartoon figurine 30, an elongated element 522 having two ends attached to the driving arm 521 and the output axle 511 respectively, and a resilient element 523 supported in the receiving cavity 11 for applying an urging force against the driving arm 521 so as to retain the movable operating part 31 of the cartoon figurine 30 in a normal position, wherein in the normal position, the movable operating part 31 remains at a predetermined position, and in a moved position, the elongated element 522 is wound around the output axle 511 so as to drive the movable operating part 31 of the cartoon figurine 30 to move through the driving arm 521 with respect to the casing 10.

Accordingly, the elongated element 522 is a durable string having a predetermined length that is long enough to attach two ends thereof to the driving arm 521 and the output axle 511 respectively wherein a portion of the elongated element 522 is arranged to wind up around the output axle 511 when the output axle 511 is driven to be rotated by the motor 51 so as to pull the driving arm 522 to move the movable operating part 31 of the cartoon figurine 30 with respect to the casing 10, as shown in FIG. 4B.

The resilient element 523, according to the preferred embodiment, is a compression spring having two ends attached to the driving arm 522 and an inner wall of the cartoon figurine 30 respectively for providing an urging force against the driving arm 522 so as to pull the elongated element 521 to unwind the output axle 511.

When the rotational movement of the output axle 511 is stopped by the transistor circuit 411, the resilient element 512 is rebounded to its original form to pull the driving arm 521 back to the original position while the elongated element 522 is unwound with respect to the output axle 511 so as to drive the movable operating part 31 of the cartoon figurine 30 back to the original normal position.

It is worth mentioning that the actuating means 52 can be constructed as a cog chain such that the rotational movement of the output axle 511 is transferred to the movable operating part 31 of the cartoon figurine 30 through the cog chain for moving the movable operating part 31 of the cartoon figurine 30.

Moreover, the movable operating part 31 of the cartoon figurine 30 is correspondingly linked to the voice converter 42 through the transistor circuit 411 so as to synchronize the voice message from the voice converter 42 with the movement of the movable operating part 31 of the cartoon figurine 30.

The voice generator 40 further comprises means 43 for actuating the voice recording device 412 to record the voice message thereto and means 44 for actuating the voice recording device 412 to play the voice message stored therein through the voice converter 42.

The recording means 43 is embodied as a record actuator provided on the casing 10 and electrically connected to the transistor circuit 411 in such a manner that when the record actuator of the recording means 43 is actuated, the voice recording device 412 is activated to receive and store the voice message.

The playing means 44 is embodied as a play actuator provided on the casing 10 and electrically connected to the transistor circuit 411 in such a manner that when the play actuator of the playing means 44 is actuated, the voice message stored in the voice recording device 412 is played through the voice converter 42.

The voice generator 40 further comprises means 45 for indicating the voice message when the voice message is stored in the voice recording device 412. The indicating means 45, which is a LED, is mounted on the front side of the casing 10 and electrically connected to the transistor circuit 411 wherein the indicating means 45 is arranged in such a manner that when the voice message is stored in the voice recording device 412, the LED of the indicating means 45 is lighted. In other words, when there is no voice message in the voice recording device 412, the LED of the indicating means 45 is turned off.

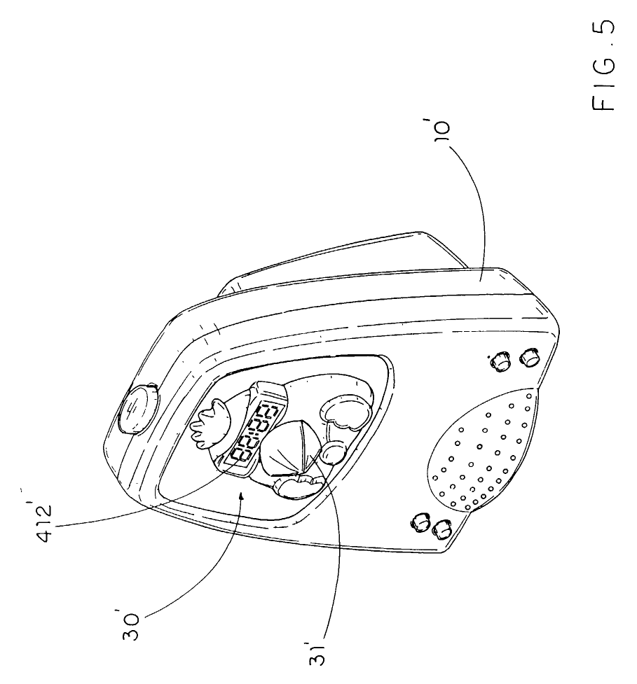

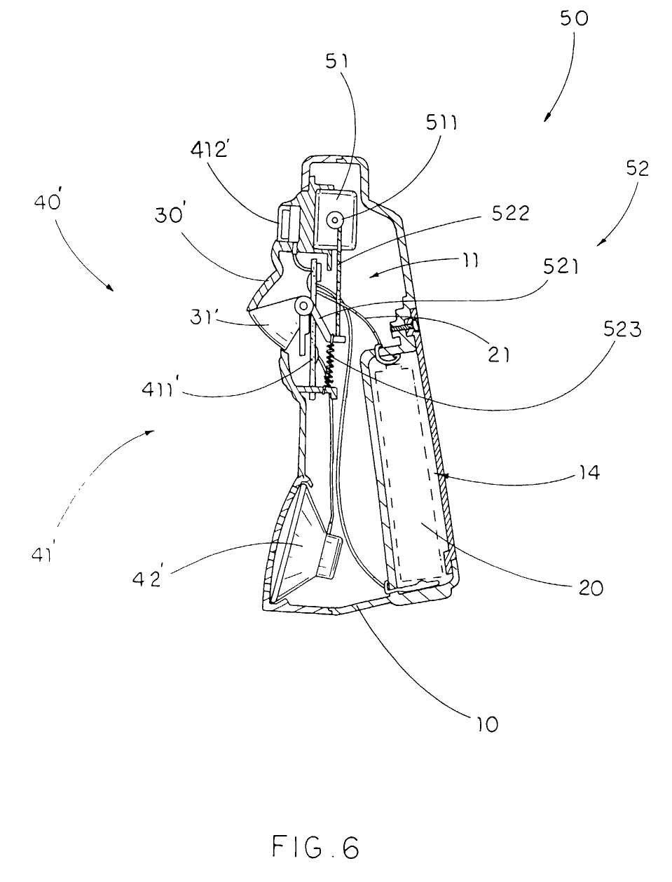

As shown in FIGS. 5 and 6, a second embodiment of the action voice recorder illustrates an alternative mode of the first embodiment of the present invention, wherein the structural designs of the second embodiment, such as the casing 10, the power source 20, the cartoon figurine 30 and the voice actuator 50, are the same as the above first embodiment, except the voice generator 40′.

According to the second embodiment, the voice activator 41′ of the voice generator 40′ is embodied as a talking clock wherein the voice activator 41′ comprises a transistor circuit 411′ electrically connected with the power output 20 and a time displaying unit 412′ electrically connected to the transistor circuit 411′ in such a manner that by activating the voice activator 41′, the voice message is played through the voice converter 42′. Accordingly, the voice message is a time audible message preset in the time displaying unit 412′.

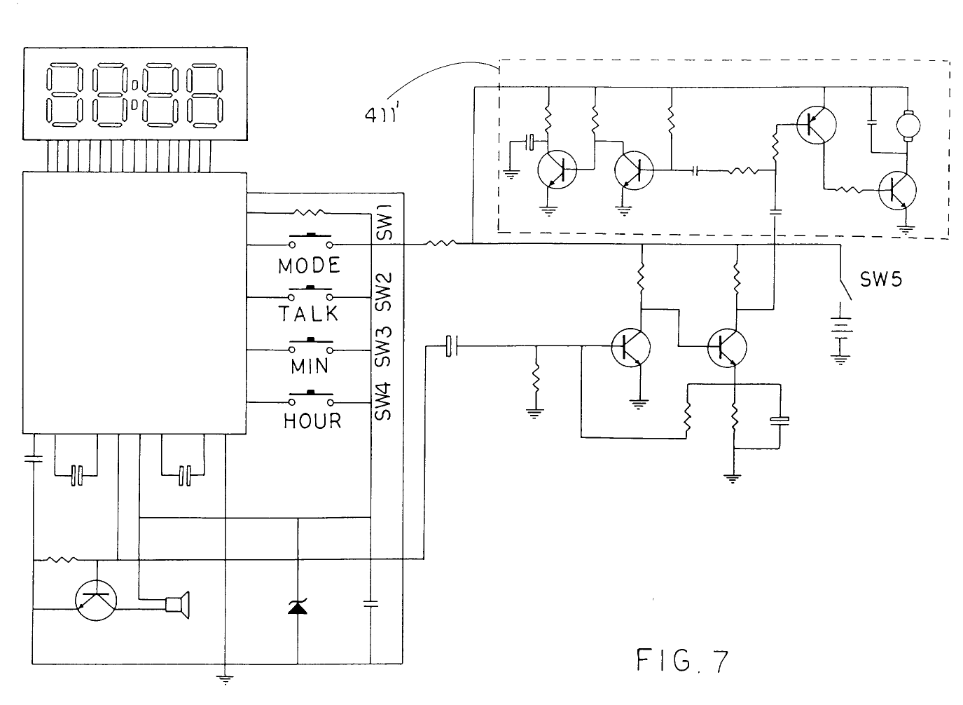

FIG. 7 illustrates a circuit diagram of the transistor circuit 411′ which is specifically designed in such a manner that the voice message is generated to the voice converter 42′ when the time displaying unit 412′ reaches a predetermined time. For example, the voice message is generated when the voice generator 40′ strikes the hours such that the movable operating part 31 of the cartoon figurine 30 is actuated by the voice actuator 50 to synchronize with the voice message.

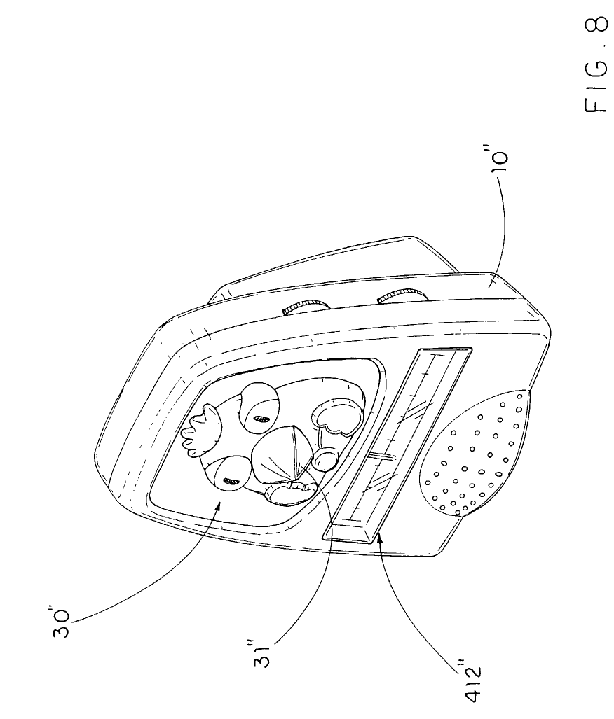

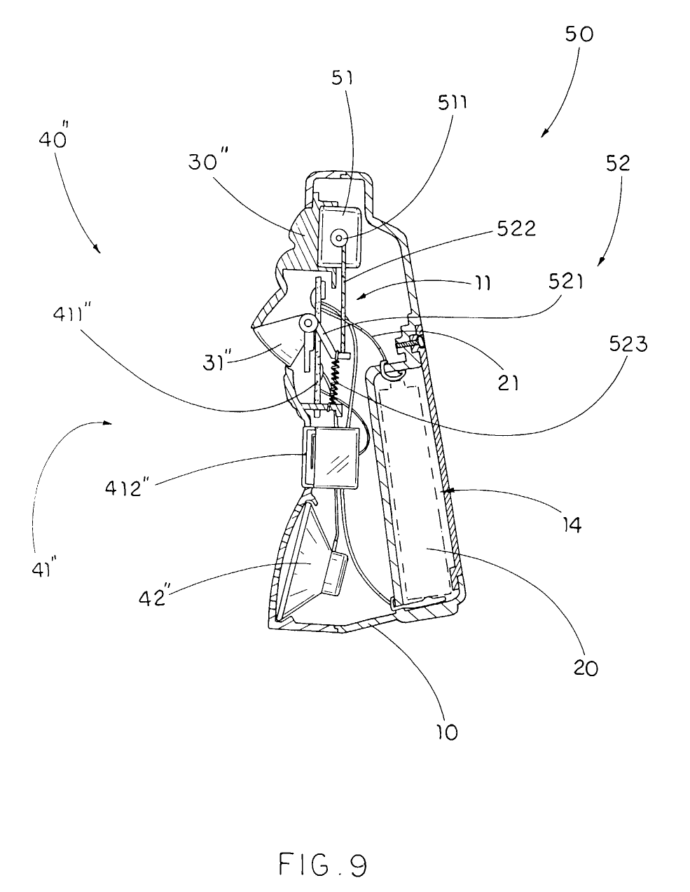

As shown in FIGS. 8 and 9, a third embodiment of the action voice recorder illustrates another alternative mode of the first embodiment, wherein the voice activator 41″ of the voice generator 40″ is embodied as a radio assembly.

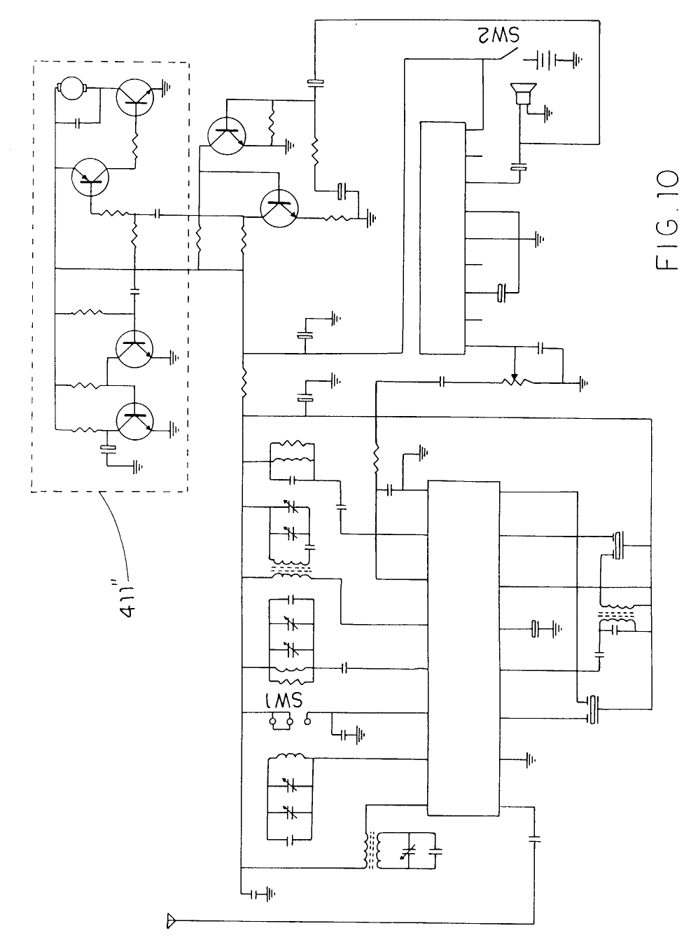

The voice activator 41″ comprises a transistor circuit 411″, which is a radio circuit, electrically connected with the power output 20 and a radio broadcasting unit 412″ electrically connected to the transistor circuit 411″ for broadcasting a sound program as the voice message. Accordingly, the circuit diagram of the transistor circuit 411″ is shown in FIG. 10. In other words, when the voice message is generated by the radio broadcasting unit 412″ through the voice converter 42″, the movable operating part 31 of the cartoon figurine 30″ is actuated by the voice actuator 50 to synchronize with the voice message.

It is worth mentioning that the power source 20 according to the first, second, and third embodiments is preferred to be embodied as the replaceable battery, especially for the first embodiment, since the voice generator 40 is embodied as a portable voice device. However, since the voice generators 40′, 40″ of the second and third embodiments, which are embodied as the talking clock device and the radio assembly respectively, the power source 20 can be used as an AC current adapter for plugging into an electric outlet.

While the foregoing description and diagram describe the preferred embodiments of the present invention, it should be appreciated that certain obvious modifications, variations, and substitutions may be made without departing from the spirit and scope of the present invention. For example, the movement of the movable operating part of the cartoon figurine can be a head shaking movement or an arm swinging movement instead of the lip talking movement. Moreover, the voice generator can be in other form of device that is capable of generating a voice message so as to synchronize with the movement of the cartoon figurine.

What is claimed is:

1. An action voice recorder, comprising:
a casing having a receiving cavity;
a power source;
a cartoon figurine comprising a movable operating part mounted on said casing;
a voice generator, which is disposed in said receiving cavity, comprising a voice activator electrically connected with said power source for generating a voice message and a sound converter electrically connected with said voice activator for converting said voice message in an audible form; and
a voice actuator electrically connected to said voice generator and arranged in such a manner that when said voice generator is activated, said voice actuator actuates said movable operating part of said cartoon figurine to move in synchronization with respect to said voice message.

2. An action voice recorder, as recited in claim 1, wherein said movable operating part of said cartoon figurine is embodied as a lip portion thereof pivotally mounted on a front side of said casing in such a manner that said lip portion of said cartoon figurine is driven to move in synchronization with respect to said voice message.

3. An action voice recorder, as recited in claim 1, wherein said voice activator comprises a transistor circuit electrically connected with said power output and a voice recording device electrically mounted on said transistor circuit for recording and storing said voice message in such a manner that by activating said voice activator, said voice message stored in said voice recording device is played through said voice converter.

4. An action voice recorder, as recited in claim 2, wherein said voice activator comprises a transistor circuit electrically connected with said power output and a voice recording device electrically mounted on said transistor circuit for recording and storing said voice message in such a manner that by activating said voice activator, said voice message stored in said voice recording device is played through said voice converter.

5. An action voice recorder, as recited in claim 3, wherein said voice actuator comprises a motor operatively connected to said transistor circuit to drive an output axle to rotate and means for actuating said movable operating part of said cartoon figurine to move when said output axle is rotated.

6. An action voice recorder, as recited in claim 4, wherein said voice actuator comprises a motor operatively connected to said transistor circuit to drive an output axle to rotate and means for actuating said movable operating part of said cartoon figurine to move when said output axle is rotated.

7. An action voice recorder, as recited in claim 5, wherein said actuating means comprises a driving arm extended from said movable operating part of said cartoon figurine, an elongated element having two ends attached to said driving arm and said output axle respectively, and a resilient element supported in said receiving cavity for applying an urging force against said driving arm so as to retain said movable operating part of said cartoon figurine in a normal position, wherein in said normal position, said movable operating part is remained at a predetermined position, and in a moved position, a portion of said elongated element is wound around said output axle so as to dive said movable operating part of said cartoon figurine to move through said driving arm with respect to said casing.

8. An action voice recorder, as recited in claim 5, wherein said actuating means comprises a driving arm extended from said movable operating part of said cartoon figurine, an elongated element having two ends attached to said driving arm and said output axle respectively, and a resilient element supported in said receiving cavity for applying an urging force against said driving arm so as to retain said movable operating part of said cartoon figurine in a normal position, wherein in said normal position, said movable operating part is remained at a predetermined position, and in a moved position, a portion of said elongated element is wound around said output axle so as to dive said movable operating part of said cartoon figurine to move through said driving arm with respect to said casing.

9. An action voice recorder, as recited in claim 3, wherein said voice generator further comprises means for actuating said voice recording device to record said voice message thereto and means for actuating said voice recording device to play said voice message stored therein through said voice converter.

10. An action voice recorder, as recited in claim 6, wherein said voice generator further comprises means for actuating said voice recording device to record said voice message thereto and means for actuating said voice recording device to play said voice message stored therein through said voice converter.

11. An action voice recorder, as recited in claim 8, wherein said voice generator further comprises means for actuating said voice recording device to record said voice message thereto and means for actuating said voice recording device to play said voice message stored therein through said voice converter.

12. An action voice recorder, as recited in claim 6, wherein said voice generator further comprises means for indicating said voice message when said voice message is stored in the voice recording device.

13. An action voice recorder, as recited in claim 8, wherein said voice generator further comprises means for indicating said voice message when said voice message is stored in the voice recording device.

14. An action voice recorder, as recited in claim 11, wherein said voice generator further comprises means for indicating said voice message when said voice message is stored in the voice recording device.

15. An action voice recorder, as recited in claim 1, wherein said voice activator comprises a transistor circuit electrically connected with said power output and a time displaying unit electrically connected to said transistor circuit in such a manner that by activating said voice activator, said voice message, which is a time audible message, is played through said voice converter.

16. An action voice recorder, as recited in claim 2, wherein said voice activator comprises a transistor circuit electrically connected with said power output and a time displaying unit electrically connected to said transistor circuit in such a manner that by activating said voice activator, said voice message, which is a time audible message, is played through said voice converter.

17. An action voice recorder, as recited in claim 15, wherein said voice actuator comprises a motor operatively connected to said transistor circuit to drive an output axle to rotate and means for actuating said movable operating part of said cartoon figurine to move when said output axle is rotated.

18. An action voice recorder, as recited in claim 16, wherein said voice actuator comprises a motor operatively connected to said transistor circuit to drive an output axle to rotate and means for actuating said movable operating part of said cartoon figurine to move when said output axle is rotated.

19. An action voice recorder, as recited in claim 17, wherein said actuating means comprises a driving arm extended from said movable operating part of said cartoon figurine, an elongated element having two ends attached to said driving arm and said output axle respectively, and a resilient element supported in said receiving cavity for applying an urging force against said driving arm so as to retain said movable operating part of said cartoon figurine in a normal position, wherein in said normal position, said movable operating part is remained at a predetermined position, and in a moved position, a portion of said elongated element is wound around said output axle so as to dive said movable operating part of said cartoon figurine to move through said driving arm with respect to said casing.

20. An action voice recorder, as recited in claim 18, wherein said actuating means comprises a driving arm extended from said movable operating part of said cartoon figurine, an elongated element having two ends attached to said driving arm and said output axle respectively, and a resilient element supported in said receiving cavity for applying an urging force against said driving arm so as to retain said movable operating part of said cartoon figurine in a normal position, wherein in said normal position, said movable operating part is remained at a predetermined position, and in a moved position, a portion of said elongated element is wound around said output axle so as to dive said movable operating part of said cartoon figurine to move through said driving arm with respect to said casing.

21. An action voice recorder, as recited in claim 1, wherein said voice activator comprises a transistor circuit electrically connected with said power output and a radio broadcasting unit electrically connected to said transistor circuit, in such a manner that by activating said voice activator, said voice message, which is an audible broadcasting message, is played through said voice converter.

22. An action voice recorder, as recited in claim 2, wherein said voice activator comprises a transistor circuit electrically connected with said power output and a radio broadcasting unit electrically connected to said transistor circuit, in such a manner that by activating said voice activator, said voice message, which is an audible broadcasting message, is played through said voice converter.

23. An action voice recorder, as recited in claim 21, wherein said voice actuator comprises a motor operatively connected to said transistor circuit to drive an output axle to rotate and means for actuating said movable operating part of said cartoon figurine to move when said output axle is rotated.

24. An action voice recorder, as recited in claim 22, wherein said voice actuator comprises a motor operatively connected to said transistor circuit to drive an output axle to rotate and means for actuating said movable operating part of said cartoon figurine to move when said output axle is rotated.

25. An action voice recorder, as recited in claim 23, wherein said actuating means comprises a driving arm extended from said movable operating part of said cartoon figurine, an elongated element having two ends attached to said driving arm and said output axle respectively, and a resilient element supported in said receiving cavity for applying an urging force against said driving arm so as to retain said movable operating part of said cartoon figurine in a normal position, wherein in said normal position, said movable operating part is remained at a predetermined position, and in a moved position, a portion of said elongated element is wound around said output axle so as to dive said movable operating part of said cartoon figurine to move through said driving arm with respect to said casing.

26. An action voice recorder, as recited in claim 24, wherein said actuating means comprises a driving arm extended from said movable operating part of said cartoon figurine, an elongated element having two ends attached to said driving arm and said output axle respectively, and a resilient element supported in said receiving cavity for applying an urging force against said driving arm so as to retain said movable operating part of said cartoon figurine in a normal position, wherein in said normal position, said movable operating part is remained at a predetermined position, and in a moved position, a portion of said elongated element is wound around said output axle so as to dive said movable operating part of said cartoon figurine to move through said driving arm with respect to said casing.
